(19) United States
(12) Patent Application Publication
(10) Pub. No.: US 2025/0297067 A1
(43) Pub. Date: Sep. 25, 2025

(54) DEGRADABLE POLYMERS FOR COATINGS, FILMS, AND ADHESIVES

(71) Applicants: BASF SE, Ludwingshafen am Rhein (DE); THE REGENTS OF THE UNIVERSITY OF CALIFORNIA, Oakland, CA (US)

(72) Inventors: Matthias GERST, Ludwigshafen (DE); Christopher BATES, Santa Barbara, CA (US); Javier Read DE ALANIZ, Santa Barbara, CA (US); Chungryong CHOI, Goleta, CA (US); Kaitlin ALBANESE, Santa Barbara, CA (US)

(73) Assignees: BASF SE, Ludwigshafen am Rhein (DE); THE REGENTS OF THE UNIVERSITY OF CALIFORNIA, Oakland, CA (US)

(21) Appl. No.: 18/845,763

(22) PCT Filed: Jan. 25, 2023
(86) PCT No.: PCT/US2023/061259

§ 371 Date: Sep. 10, 2024

Related U.S. Application Data
(60) Provisional application No. 63/321,254, filed on Mar. 18, 2022.

(51) Int. Cl. C08G 75/06; C08J 11/28; C09J 7/38

(52) U.S. Cl. CPC C08G 75/06; C08J 11/28; C09J 7/38; C08G 2230/00; C08J 2381/02; C09J 2203/334; C09J 2301/302; C09J 2301/414

(57) ABSTRACT

A degradable polymer which is a copolymer of up to 50 mol % of an organosulfur monomer comprising a cyclic disulfide group and at least 50 mol % of at least one organic monomer selected from the group consisting of an acid functional monomer, a base functional monomer, a polar monomer, a vinyl monomer or a combination thereof. Use of an organosulfur monomer as a co-monomer introduces cleavable disulfide bonds into the primary backbone of polymer, which renders the polymer readily degradable.

### TECHNICAL FIELD

The present disclosure generally relates to degradable polymers for coatings, films, and adhesives and the like. In particular, the disclosure relates to a new class of degradable polymers that share the performance attributes of current commercial materials with the added benefit that they are configurable with high molecular weights and tunable degradation.

### BACKGROUND

There are a number of polymer-based products for which degradability would be desirable. For example, films and laminates that are used in packaging materials, coatings, adhesives, and as seed coverings are intended to survive intact for only a short period of use. Other polymer-based products for which degradability is desirable are molded articles.

Several approaches to enhance the environmental degradability of polymers have been suggested and tried. However, there remains a need for the preparation of degradable polymers with high molecular weight that share the performance attributes of current commercial materials.

### SUMMARY

The present disclosure provides a degradable polymer which is a copolymer of up to 50 mol % of an organosulfur monomer comprising a cyclic disulfide group and at least 50 mol % of at least one organic monomer selected from the group consisting of an acid functional monomer, a base functional monomer, a polar monomer, vinyl monomer or a combination thereof. Use of an organosulfur monomer as a co-monomer introduces cleavable disulfide bonds into the primary backbone of polymer, which renders the polymer readily degradable by chemical or biological mechanisms.

### BRIEF DESCRIPTION OF THE DRAWINGS

The drawings described below are for illustration purposes only. The drawings are not intended to limit the scope of the present disclosure.

FIG. 1 is a schematic of an exemplary polymerization reaction.

FIG. 2 shows reactions of exemplary monomers in a polymerization reaction.

FIG. 3 shows exemplary degradation reaction conditions.

FIG. 4A shows a concentration effect on an exemplary polymerization reaction of a lipoate ester and n-butyl acrylate and subsequent degradation of the polymer.

FIG. 4B shows a molecular weight analysis of the polymers prepared in FIG. 4A and their degradation products.

FIG. 4C shows a degradation linkage analysis of the degradation products of the polymer prepared in FIG. 4A.

FIG. 5A shows a temperature effect on an exemplary polymerization reaction of a lipoate ester and n-butyl acrylate and subsequent degradation of the polymer.

FIG. 5B shows a molecular weight analysis of the polymers prepared in FIG. 5A and their degradation products.

FIG. 5C shows a degradation linkage analysis of the degradation products of the polymers prepared in FIG. 5A.

FIG. 6 shows an analysis of the glass transition temperatures of polymers of lipoate ester and n-butyl acrylate.

FIG. 7A shows an exemplary polymerization reaction of lipoic acid, n-butyl acrylate and acrylic acid.

FIG. 7B shows a molecular weight analysis of the polymer prepared in FIG. 7A and its degradation products.

FIG. 8A shows an exemplary polymerization reaction of lipoic acid, n-butyl acrylate and acrylic acid.

FIG. 8B shows an analysis of the storage modulus (•) and loss modulus (º) of the polymer prepared in FIG. 8A compared to a conventional pressure sensitive adhesive.

FIG. 8C shows a molecular weight analysis of the polymer prepared in FIG. 8A compared to a conventional pressure sensitive adhesive.

FIG. 9A shows an exemplary polymerization reaction of lipoic acid ester, n-butyl acrylate and acrylic acid.

FIG. 9B shows a molecular weight analysis of the polymer prepared in FIG. 9A and its degradation products.

FIG. 10A shows an exemplary polymerization reaction of lipoic acid ester, n-butyl acrylate and tert-butyl acrylate.

FIG. 10B shows a molecular weight analysis of the polymer prepared in FIG. 10A and its degradation products.

FIG. 11A shows an exemplary polymerization reaction of a lipoate ester, n-butyl acrylate and 1,4-butanediol diacrylate.

FIG. 11B shows the WLp polymer prepared in FIG. 11A before and after degradation.

FIG. 11C shows the W/O Lp polymer prepared by the procedure in FIG. 11A but without the lipoate ester component, which does not degrade under the same conditions.

FIG. 11D shows a molecular weight analysis of the degradation products of the WLp polymer prepared in FIG. 11A.

FIG. 12 shows the UV absorbance of an exemplary polymer after degradation with and without functionalization with a dye.

FIG. 13A shows exemplary lipoate ester and styrene monomer units.

FIG. 13B shows the conversion rate of the monomers of FIG. 13A in a polymerization reaction.

FIG. 13C shows a molecular weight analysis of the undegraded polymer of the monomers of FIG. 13A and the degradation products.

FIG. 13D shows an analysis of the glass transition temperatures of polymers prepared from the monomers of FIG. 13A.

FIG. 14A shows exemplary lipoate ester and methacrylate monomer units.

FIG. 14B shows the conversion rate of the monomers of FIG. 14A in a polymerization reaction.

FIG. 15 shows a master curve generated for PELp.

FIG. 16 shows the entanglement molecular weights for PELp (left) and PnBA (right).

FIG. 17 shows DSC traces of homopolymers taken on the second heat cycle with a ramp rate of 10° C. min⁻¹ and the exotherm positioned up.

FIG. 18 shows a representative 1H-NMR analysis of degraded ELp-nBA copolymer with characteristic resonances highlighted.

FIG. 19 shows a diagram of the effect of polymerization conditions on degradability of lipoic-acid-acrylate copolymers

FIG. 20A shows a size-exclusion chromatography plots evaluating the effect of polymerization monomer concentrations ([M]) on degradability.

FIG. 20B shows a size-exclusion chromatography graph evaluating polymerization temperatures (T) on degradability.

FIG. 21A shows the lap shear of degradable αLA-ELp-nBA compared to conventional nBA-AA copolymers using a uniaxial extension rate of 0.5 mm min⁻¹.

FIG. 21B shows the resuls of a 180° peel test with a uniaxial extension rate of 100 mm min⁻¹ of degradable αLA-ELp-nBA compared to conventional nBA-AA copolymers.

FIG. 22A shows the preparation of αLA-ELp-nBA PSA (left) and traditional acrylic PSA (right) as an adhesive of water bottle labels.

FIG. 22B shows the bottles of FIG. 22A submerged in THF:water at t=0.

FIG. 22C shows the bottles of FIG. 22A submerged in THF:water at t=4.

FIG. 23 schematically shows that functional chain ends produced after degradation undergoing repeated oxidative repolymerization and reductive degradation for closed-loop recycling of αLA-ELp-nBA PSA.

FIG. 24 shows size-exclusion chromatography analysis of repeated oxidative repolymerization and reductive degradation of a degradable αLA-ELp-nBA PSA.

### DETAILED DESCRIPTION

In the following description, numerous specific details are set forth, such as particular structures, components, materials, dimensions, processing steps, and techniques, in order to provide a thorough understanding of the present embodiments. However, it will be appreciated by one of ordinary skill of the art that the embodiments may be practiced without these specific details. In other instances, well-known structures or processing steps have not been described in detail in order to avoid obscuring the embodiments.

The present disclosure is related to compositions of degradable polymers that are readily synthesized from simple chemical building blocks and methods of making the same. Advantageously, the compositions may exhibit high molecular weights and tunable degradation. The disclosed polymer compositions can also be advantageously configured to retain or even desirably alter the performance attributes of current commercial materials with the added benefit that the disclosed polymers are degradable. Imparting a degradability property to materials made from conventional polymers provides a mechanism to reduce plastic waste and improve sustainability. Examples of application spaces include: coatings or films in the packaging industry, adhesives, paper coating, printing inks, foils, personal care/cosmetic, e.g. for hair, skin, wash, laundry, agriculture, e.g. seed protection, resins, films, solutions, and emulsion/dispersion.

We have developed a new class of degradable polymers that are readily synthesized from simple chemical building blocks. The key features of these materials are (i) high molecular weights which are crucial for commercial applications and (ii) tunable degradation, including chemical or biological degradation through the incorporation of an organosulfur monomer comprising a cyclic disulfide group. The degradable polymers of this disclosure are a copolymer of an organosulfur monomer comprising a cyclic disulfide group and at least one organic monomer, such as styrene, an acrylate, or vinyl acetate. As shown in FIG. 1, copolymerization using an organosulfur monomer results in incorporation of sulfur atoms, including disulfide bonds, into the primary backbone of the polymer. The resulting polymer is degradable by chemical degradation, such as by chemical reduction or biodegradation, via cleavage where the organosulfur monomer is incorporated in the primary backbone.

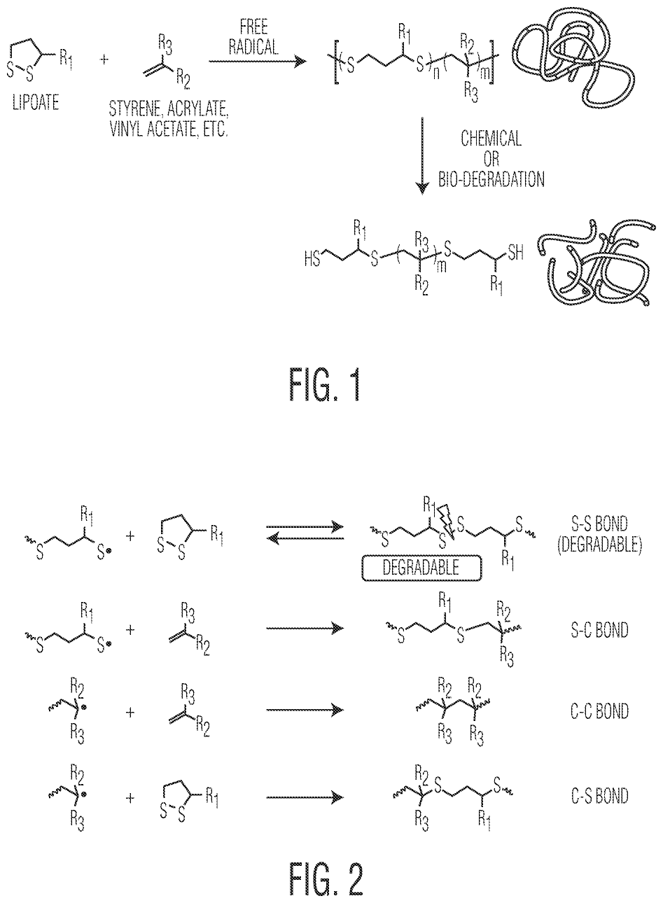

As shown in FIG. 2, in radical polymerization, both the organosulfur monomer and organic monomer may react with radicals to generate new radicals. A radical of the organosulfur monomer may form a bond to another organosulfur monomer or an organic monomer. Likewise, a radical of the organic monomer may form a bond to the organosulfur monomer or another organic monomer. A disulfide bond (S—S bond) may form in the primary backbone of the polymer where two organosulfur monomers bond to one another during polymerization. The disulfide bond is highly degradable. Additionally, C—S and S—C bonds formed by bonding of the organosulfur monomer with an organic monomer may provide alternative sites for initiating degradation.

Upon degradation of the disulfide or thioether bonds, the polymer is broken down into oligomers having a fractional size relative to the undegraded polymer. Incorporation of higher number of disulfide bonds in the primary backbone of the polymer is associated with degradation into oligomers having a smaller molecular weight compared to a polymer having a lower number of disulfide bonds in its primary backbone.

Thus, without wishing to be bound by theory, the degradation of the degradable polymers of this disclosure may be “tunable” by controlling the amount of organosulfur monomers forming the repeating units of the primary polymer backbone and the resulting number of disulfide bonds within the primary backbone. In some examples, at least 1% of bonds between repeating units of the primary backbone of the degradable polymer are disulfide bonds. More preferably, at least 5%, at least 10%, at least 15%, at least 20% or at least 25% of bonds between repeating units of the primary backbone of the degradable polymer are disulfide bonds. An upper limit of disulfide bonds between repeating units of the primary backbone of the degradable polymer is generally limited by the performance properties of the resulting polymer. Suitably, the proportion of disulfide bonds among the bonds between repeating units of the primary backbone of the degradable polymer may be 50% or less, 45% or less, 40% or less, 35% or less, or 30% or less.

Suitable organosulfur monomers generally comprise a cyclic disulfide group available for radical ring-opening polymerization. The cyclic disulfide group include two covalently bonded sulfur atoms and preferably between 1 to 6 carbon atoms in their rings, in addition to the two sulfur atoms. Suitable cyclic disulfides are available commercially. The reduced form of the cyclic disulfides can also be used. In some aspects, a hydrocarbon moiety is attached to the cyclic disulfide of the organosulfur monomer. The hydrocarbon moiety may be hydrocarbyl, substituted hydrocarbyl, hetero-hydrocarbyl, or substituted hetero-hydrocarbyl, optionally with a functional group selected from the group consisting of amino, ammonio, imino, amido, imidyl, nitrile, azo, azido, cyano, cyanato, isocyanato, isothiocyanto, hydrazide, nitro, nitroso, nitrosooxy, pyridyl, hydroxyl, alkoxy, carboxyl, ester, acyl, halo, haloformyl, phosphino, phosphoric, phospho, sulfide, disulfide, thio, thiol, sulfonyl, sulfo, sulfinyl, alkenyl, alkynl, allenyl, and silyl. Preferred examples include lipoic acid and lipoic acid derivatives, such as but not limited to the amide and esters, such as alkyl lipoamides and alkyl lipoates, including ethyl lipoamide, ethylhexyl lipoamide, ethyl lipoate, n-butyl lipoate, and ethylhexyl lipoate.

In some examples, the organosulfur monomer has the structure of Formula (1):

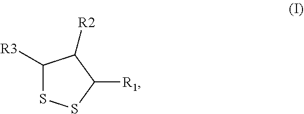

where R₁, R₂ and R₃, are each independently selected from the group consisting of hydrocarbyl, substituted hydrocarbyl, hetero-hydrocarbyl, or substituted hetero-hydrocarbyl, optionally with a functional group selected from the group consisting of amino, ammonio, imino, amido, imidyl, nitrile, azo, azido, cyano, cyanato, isocyanato, isothiocyanto, hydrazide, nitro, nitroso, nitrosooxy, pyridyl, hydroxyl, alkoxy, carboxyl, ester, acyl, halo, haloformyl, phosphino, phosphoric, phospho, sulfide, disulfide, thio, thiol, sulfonyl, sulfo, sulfinyl, alkenyl, alkynl, allenyl, and silyl. Additionally, although Formula (1) is shown with three carbon atoms, it should be understood that the ring may alternatively include a different number of carbon atoms, such as preferably from 1 to 6 carbon atoms. It should also be understood that the R1 group can be connected to any one of the carbons in the ring, or there can be multiple R1 groups connected to any combination of the carbon atoms in the ring, or the R1 group can be connected to a functional group such as amino, alkoxy, carboxyl, ester, acyl, thio and silyl.

Suitable organic monomers are not particularly limited. An organic monomer can be polymerized with the organosulfur monomer alone or in combination with one or more other organic monomers. Exemplary organic monomers comprise acid functional monomers, where the acid functional group may be an acid per se, such as a carboxylic acid, or a portion may be salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, itaconic acid, fumaric acid, crotonic acid, citraconic acid, maleic acid, oleic acid, ß-carboxyethyl(meth)acrylate, 2-sulfoethyl methacrylate, styrene sulfonic acid, 2-acrylamido-2-methylpropanesulfonic acid, vinylphosphonic acid, and mixtures thereof. Exemplary polar monomers include but are not limited to N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; alkyl vinyl ethers, including vinyl methyl ether; and mixtures thereof. Exemplary non-polar monomers include ethyl (meth)acrylate, n-propyl (meth)acrylate, isopropyl (meth)acrylate, n-butyl (meth)acrylate, isobutyl(meth)acrylate, tert-butyl (meth)acrylate, n-pentyl (meth)acrylate, iso-pentyl (meth)acrylate (i.e., iso-amyl (meth)acrylate), 3-pentyl (meth)acrylate, 2-methyl-1-butyl (meth)acrylate, 3-methyl-1-butyl (meth)acrylate, stearyl (meth)acrylate, phenyl (meth)acrylate, n-hexyl (meth)acrylate, iso-hexyl (meth)acrylate, cyclohexyl (meth)acrylate, 2-methyl-1-pentyl (meth)acrylate, 3-methyl-1-pentyl (meth)acrylate, 4-methyl-2-pentyl (meth)acrylate, 2-ethyl-1-butyl (meth)acrylate, 2-methy-1-hexyl (meth)acrylate, 3,5,5-trimethyl-1-hexyl (meth)acrylate, cyclohexyl (meth)acrylate, 3-heptyl (meth)acrylate, benzyl (meth)acrylate, n-octyl (meth)acrylate, iso-octyl (meth)acrylate, 2-octyl (meth)acrylate, 2-ethyl-1-hexyl (meth)acrylate, n-decyl (meth)acrylate, iso-decyl (meth)acrylate, isobornyl (meth)acrylate, 2-propylheptyl (meth)acrylate, isononyl (meth)acrylate, isophoryl (meth)acrylate, n-dodecyl (meth)acrylate (i.e., lauryl (meth)acrylate), n-tridecyl (meth)acrylate, iso-tridecyl (meth)acrylate, 3,7-dimethyl-octyl (meth)acrylate, and any combinations or mixtures thereof. Exemplary base functional monomers include N,N-dimethyl(meth)acrylamide (NNDMA); N,N-diethyl(meth)acrylamide; N,N-dimethylaminopropyl methacrylamide (DMAPMAm); N,N diethylaminopropyl methacrylamide (DEAPMAm); N,N-dimethylaminoethyl acrylamide (DMAEAm); N,N-dimethylaminoethyl methacrylamide (DMAEMAm); N,N diethylaminoethyl acrylamide (DEAEAm); N,N-diethylaminoethyl methacrylamide (DEAEMAm); N-vinyl formamide, (meth)acrylamide; N-methyl acrylamide, N-ethyl acrylamide; n-butyl acrylate; tert-butyl acrylate; 1,4-butanediol diacrylate; N,N-dimethylaminoethyl acrylate (DMAEA); N,N-diethylaminoethyl acrylate (DEAEA); N,N-dimethylaminopropyl acrylate (DMAEA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinyl pyrrolidone, N-vinyl caprolactam, acrylonitrile, and mixtures thereof. Exemplary vinyl monomers include acrylates, substituted acrylates, vinyl esters (e.g., vinyl acetate and vinyl propionate), styrene, substituted styrene (e.g., α-methyl styrene), vinyl halide, and mixtures thereof. Exemplary monomers further include aliphatic or aromatic comonomer units. In some aspects the organic monomers are bifunctional or trifunctional. Styrene, acrylate, and vinyl acetate monomers are preferred.

In some aspects, the degradable polymer comprises a ratio of the organosulfur monomer structural unit with respect to all structural units of up to 50 mol %. Suitably, the degradable polymer comprises a mass ratio of up to 45 mol %, up to 40 mol %, up to 35 mol %, up to 35 mol %, up to 25 mol %, up to 20 mol %, up to 15 mol % or up to 10 mol % of the organosulfur monomer.

In some aspects, the degradable polymer comprises a mole ratio at least 50 mol % of an organic monomer or combination of organic monomer in total. Suitably, the degradable polymer comprises a mass ratio at least 50 mol %, at least 55 mol %, at least 60 mol %, at least 65 mol %, at least 70 mol %, at least 75 mol %, at least 80 mol %, at least 85 mol % or at least 90 mol % of the organic monomer or combination of organic monomers in total.

In some aspects, the degradable polymer comprises a mole ratio of at least 1 mol % of a styrene organic monomer in combination with an organic monomer other than styrene. Suitably, the degradable polymer comprises a mass ratio of at least 2 mol %, at least 3 mol %, at least 4 mol %, at least 5 mol %, at least 10 mol %, at least 15 mol %, at least 20 mol %, or at least 25 mol % of a styrene organic monomer in combination with an organic monomer other than styrene.

A polymerization initiator, chain transfer agent, emulsifier and the like may be used for polymerization. The polymerization initiator is not particularly limited and can be appropriately selected and used provided that the initiator does not destroy the organosulfur monomer. Preferably, the polymerizing takes place in the presence of an azo or non-oxidizing polymerization initiator, such as V-65 (2,2′-azobis (2.4-dimethyl valeronitrile) available from Wako Specialty Chemicals, CAS NO. 4419-11-8) or V-70 (2,2′-azobis (4-methoxy-2.4-dimethyl valeronitrile, available from Wako Specialty Chemicals, CAS NO. 15545-97-8) and the like. The polymerization initiator may be used alone or in combination of two or more, but the total content is generally 0.005 to 2.5 part by weight with respect to 100 parts by weight of the monomer, more preferably about 0.02 to 1.5 parts by weight.

The degradable polymers may be soluble in water or an organic solvent or may be water insoluble.

The degradable polymers can be prepared using a crosslinking agent. Examples of crosslinking agents include diacrylate crosslinking agents, distyrene crosslinking agents, isocyanate crosslinking agents, epoxy crosslinking agents, silicone crosslinking agents, oxazoline crosslinking agents, aziridine crosslinking agents, silane crosslinking agents, alkyl-etherified melamine crosslinking agents, metal chelate crosslinking agents, crosslinkers such as oxides are included. A crosslinking agent can be used alone or in combination of two or more. As said crosslinking agent, an isocyanate type crosslinking agent and an epoxy-type crosslinking agent are used preferably. Degradable polymers may also be prepared by cross-linking of keto groups with dihydrazine (e.g. DAAM with ADDH) and copolymerizable UV photoinitiators.

The crosslinking agent may be used alone or in combination of two or more, but the total content is based on 100 parts by weight of the degradable polymer. It is preferable to contain the said crosslinking agent in 0.01 to 5 weight part. The content of the crosslinking agent is preferably 0.01 to 4 parts by weight, more preferably 0.02 to 3 parts by weight.

The degradable polymers may be synthesized by radical polymerization techniques. Typically, the method includes copolymerizing at least two monomers by a copolymerization process, wherein at least one of the comonomers is an organosulfur monomer capable of incorporating a degradable functionality into the polymer by polymerization.

An example of the method also includes polymerizing monomers in a chain extension polymerization to form a degradable polymer. The copolymers can be polymerized by techniques including, but not limited to, the conventional techniques of solvent polymerization, emulsion polymerization, dispersion polymerization, and solventless bulk polymerization. Polymerization may be batch or semibatch.

Polymerization via emulsion techniques may require the presence of an emulsifier (which may also be called an emulsifying agent or a surfactant). Useful emulsifiers for the present invention include those selected from the group consisting of anionic surfactants, cationic surfactants, nonionic surfactants, and mixtures thereof. Preferably, an emulsion polymerization is carried out in the presence of anionic surfactant(s). A useful range of surfactant concentration is from about 0.5 to about 8 weight percent, preferably from about 1 to about 5 weight percent, based on the total weight of all monomers of the degradable polymer.

The process of emulsion polymerization with an organosulfur monomer generally requires a styrene monomer component during the process, otherwise the emulsion may not be stable enough when lipoic acid is added into the system. Nevertheless, preparation of an emulsion with a monomer mass ratio of up to 50% lipoic acid and 50% comonomers is possible. Dispersions with a mass ratio of 12.5% (˜1:12 molar ratio), 25% (˜1:6 molar ratio) and 50% lipoic acid (˜1:3 molar ratio) have been polymerized.

A typical solution polymerization method may be carried out by adding the monomers, a suitable solvent, and an optional chain transfer agent to a reaction vessel, adding a free radical initiator, purging with nitrogen, and maintaining the reaction vessel at an elevated temperature, typically in the range of about 25 to 100° C. until the reaction is completed, typically in about 1 to 20 hours, depending upon the batch size and temperature. Suitable temperatures include from 25° C. to 80° C., preferably about 30° C. to about 70° C., or more preferably about 40° C. to about 60° C. Examples of suitable solvent include methanol, tetrahydrofuran (THF), ethanol, isopropanol, acetone, methyl ethyl ketone, methyl acetate, ethyl acetate, toluene, xylene, dichloromethane (DMC) and an ethylene glycol alkyl ether. Those solvents can be used alone or as mixtures thereof. As a specific example of solution polymerization, the reaction is performed under an inert gas stream such as nitrogen, and a polymerization initiator is added, and the reaction is usually performed at about 50 to 70°° C. under reaction conditions of about 5 to 30 hours.

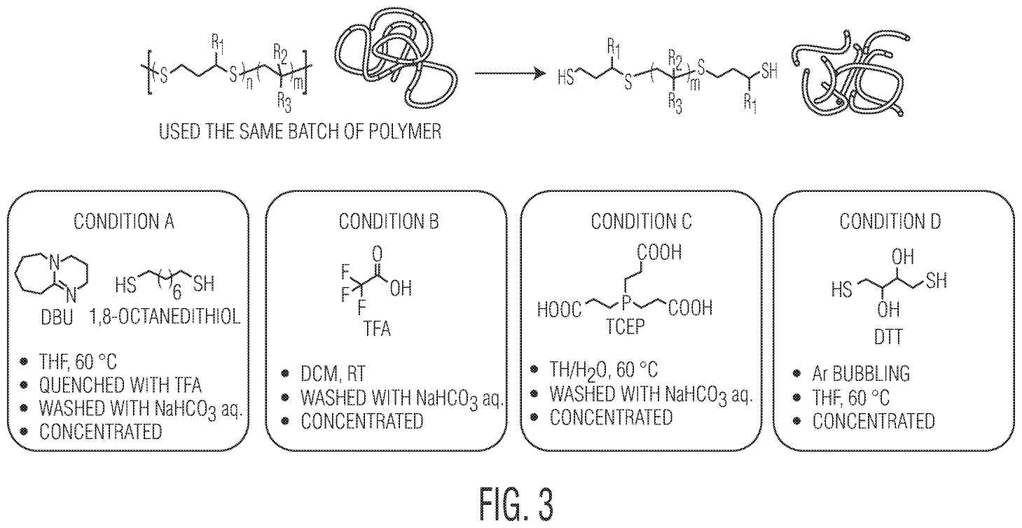

Degradation of the degradable polymers may be accomplished by various methods, including chemical degradation and biodegradation. As shown in FIG. 3, chemical degradation may take place by various means, including treatment with amidine compounds, such as 1,8-diazabicyclo[5.4.0]undec-7-ene (DBU), 1,8-octanedithiol, acids, bases, organofluorine compounds, such as trifluoroacetic acid (TFA), reducing agents such as tris(2-carboxyethyl)phosphine (TCEP), or a redox reagent, such as dithiothreitol (DTT). Degradation may take place in the presence of a solvent, such as toluene, tetrahydrofuran (THF) or dichloromethane (DMC), possibly at an elevated temperature. Suitable temperatures include from 25° C. to 80° C., preferably about 30° C. to about 70° C., or more preferably about 35° C. to about 60° C.

The degradable polymers may advantageously have a high molecular weight, such as a weight average molecular weight greater than 100,000 Da. The degradable polymers may have a number average molecular weight greater than 125,000 Da, greater than 150,000 Da or greater than 200,000 Da. An upper limit of the weight average molecular weight is generally limited by the performance properties of the resulting polymer. Suitable upper limits may be 2,000,000 Da or less, 1,000,000 Da or less, 500,000 Da or less, 450,000 Da or less, 400,000 Da or less, or 300,000 Da or less. The number average molecular weight may be determined by size exclusion chromatography (SEC) or, when the initiator has a group which can be easily distinguished from the monomer(s) by NMR spectroscopy.

Degradation of the degradable polymers breaks down the polymer into oligomers having a fractional size relative to the undegraded polymer. Upon degradation, a ratio of the number average molecular weight of degradation products of the degradable polymers relative to the undegraded form of the degradable polymer is between 0.001 to 0.1, preferably between 0.005 and 0.08, more preferably between 0.01 and 0.05.

The degradable polymers also encompass novel block, multi-block, star, gradient, random, graft, comb, hyperbranched and dendritic degradable copolymers, as well as degradable polymer networks and other degradable polymeric materials.

The degradable polymers advantageously retain the performance attributes of current commercial materials with the added benefit that they are degradable, providing a mechanism to reduce plastic waste and improve sustainability. For example, the degradable polymers may be used to control the glass transition temperature of the polymer relative to a comparable polymer prepared without an organosulfur monomer. In addition, when such degradable polymers are used as adhesives, it is possible to easily separate glued parts or laminates from each other. This debonding-on-demand supports recycling. In such examples, an organosulfur monomer may be selectively incorporated with organic monomers to obtain a polymer with increased or decreased glass transition temperature relative to a polymer having only the organic monomers. For applications as an adhesive a T_{g} of −20° C. or less is preferred. For architectural coating applications, a T_{g} of −10° C. to 20° C. is preferred. For paper coating and fiber bonding a T_{g} of 40°° C. to 80° C. is preferred.

The degradable polymers of this disclosure are advantageously suitable for recycling, particularly closed-loop recycling. Suitable methods include subjecting the degradable polymer of this disclosure to conditions that reduce the disulfide bonds of the degradable polymer to obtain degraded fragments of the degradable polymer. The degraded fragments of the degradable polymer may be repolymerized by any suitable technique to obtain a recycled degradable polymer. Advantageously, the recycling process can be further repeated one, two, three or more times. For example, the disulfide bonds of the recycled degradable polymer may be subjected to conditions that reduce the disulfide bonds to obtain degraded fragments of the recycled degradable polymer, and the degraded fragments of the recycled degradable polymer may be re-polymerized to obtain a twice-recycled degradable polymer.

### EXAMPLES

To synthesize ethyl lipoate, ethanol (16.8 g), lipoic acid (25.0 g), 4-dimethylaminopyridine (16.3 g) and 1-ethyl-3-(−3-dimethylaminopropyl) carbodiimide hydrochloride (25.6 g) were added in 300 mL of dichloromethane and stirred for 24 h at room temperature.

Lipoic acid was obtained from commercially available sources.

Copolymerization was generally conducted by mixing monomers at the desired ratios (e.g., 10.9 g n-butyl acrylate, 0.4 g acrylic acid and 3.7 g lipoate) in a reactor, then an initiator (e.g., WAKO V65 or WAKO V70 initiator) was added into cooled monomer mixture in an ice bath. Monomer solution was purged with argon gas sufficiently (e.g. for 20 min) and the polymerization was initiated by placing the reactor in an oil bath at 40° C. Polymerization was quenched by cooling down with liquid nitrogen and the synthesized polymer was isolated by precipitating in methanol and drying under high vacuum.

Conversions during polymerization were monitored by Nuclear Magnetic Resonance (NMR, Varian Unity Inova 500 MHz) using CDCl₃ and acetone-d₆ as deuterated solvents. Molecular weight of the synthesized polymer was measured by a differential refractive index (RI) detector, photodiode array (PDA) detector-equipped gel permeation chromatography (GPC, Waters Alliance HPLC system) using PLgel, 5 μm MiniMIX-D, 250×4.6 mm columns with dimethylformamide (DMF) as the eluent. Thermal properties of the polymers were observed by differential scanning calorimetry (DSC) with data collected on a TA Instruments Discovery DSC 2500 equipped with a liquid nitrogen cooler at a ramp rate of 10° C./min. Rheological property was collected with Advanced Rheometric Expansion System (ARES-G2, TA instrument).

### Example 1: Pressure Sensitive Adhesive (Concentration Effect)

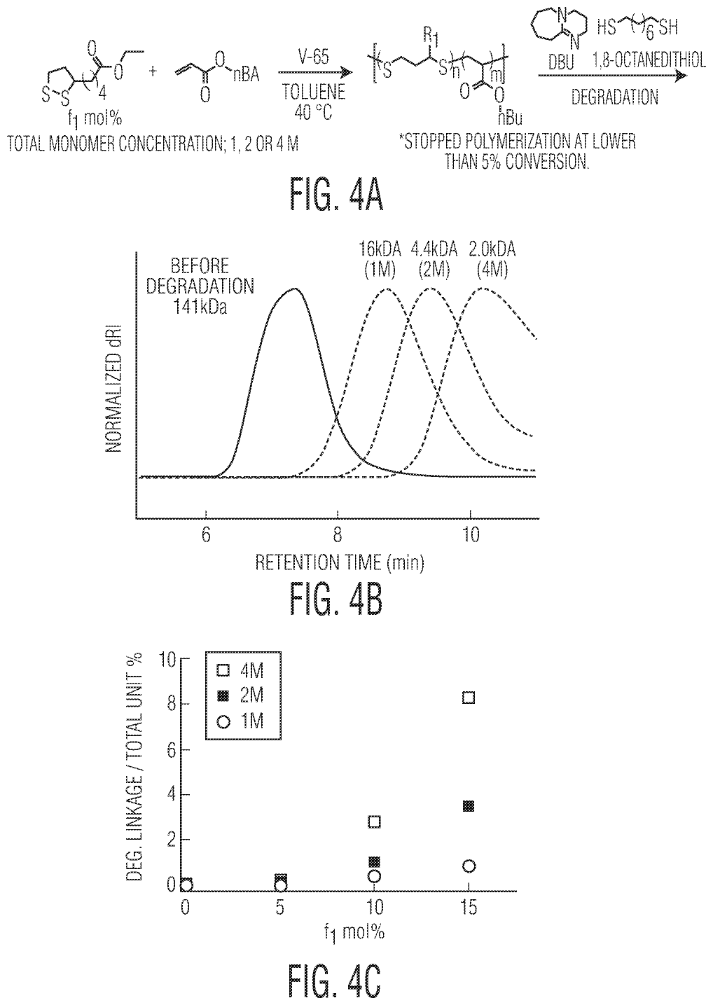

Monomer units of lipoate ester at a total monomer concentration of 1, 2 or 4 M and n-butyl acrylate were polymerized according to the reaction conditions set forth in FIG. 4A to obtain a degradable polymer. Samples of the degradable polymer were chemically degraded according to the reaction conditions set forth in FIG. 4A. The molecular weights of the undegraded polymer and degradation products obtained from reactions with a total lipoate ester monomer concentration of 1, 2 or 4 M were measured and the results are shown in FIG. 4B. The undegraded polymer had a number average molecular weight of 141 kDa relative to polystyrene standards. The molecular weight of the degradation product varied according to the lipoate ester monomer concentration, with the total monomer concentration of 1, 2 or 4 M respectively resulting in a number average molecular weight of the degraded polymer of 16 kDa, 4.4 kDa and 2.0 kDa relative to polystyrene standards. The degradation linkage/total % was measured by comparing the molecular weight before and after degradations with the results shown in FIG. 4C.

### Example 2: Pressure Sensitive Adhesive (Temperature Effect)

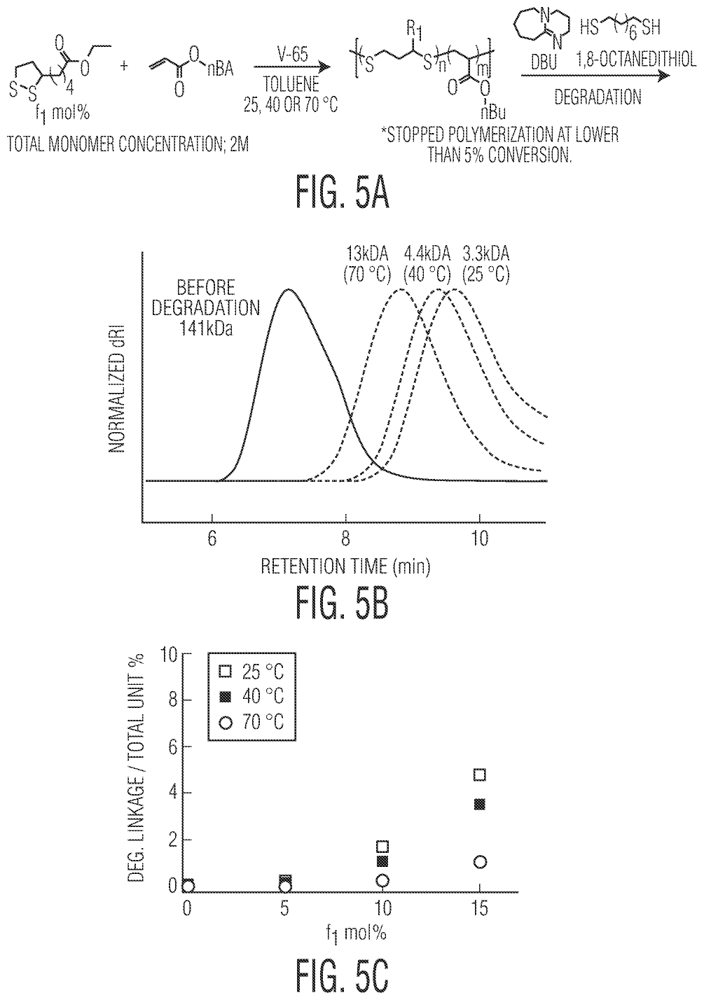

Monomer units of lipoate ester at a total monomer concentration of 2 M and n-butyl acrylate were polymerized according to the reaction conditions set forth in FIG. 5A to obtain a degradable polymer. Samples of the degradable polymer were chemically degraded according to the reaction conditions set forth in FIG. 5A. The molecular weights of the undegraded polymer and degradation products obtained from reactions at 25° C., 40° C. or 70° C. were measured and the results are shown in FIG. 5B. The undegraded polymer had a number average molecular weight of 141 kDa relative to polystyrene standards. The molecular weight of the degradation product varied according to polymerization reaction temperature, with the reaction temperature at 25° C., 40° C. or 70° C. respectively resulting in a number average molecular weight of the degraded polymer of 3.3 kDa, 4.4 kDa and 13 kDa relative to polystyrene standards. The degradation linkage/total % was measured and the results are shown in FIG. 5C.

### Example 3: Effect on Glass Transition Temperature

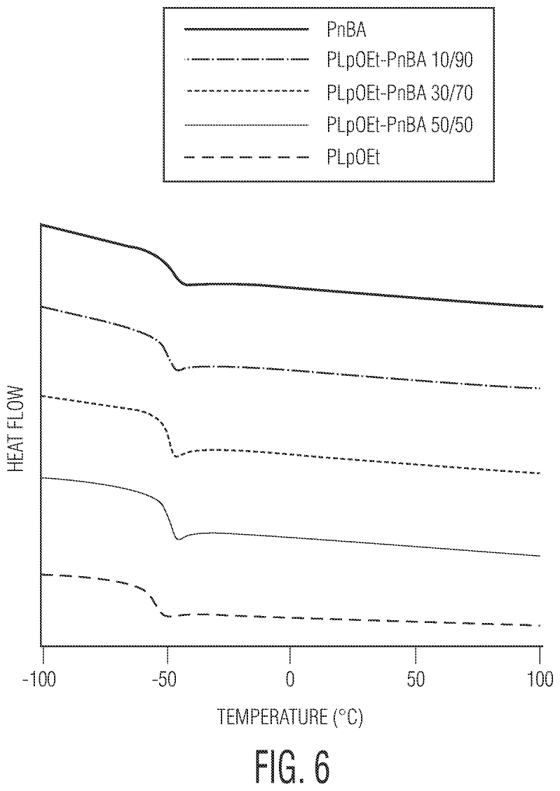

The effect of incorporation of a lipoate ester co-monomer on the glass transition temperature of poly (n-butyl acrylate) (PnBA) was evaluated. Copolymers were prepared with lipoate ester monomer and nBA monomer at mole ratios of 0, 10/90, 30/70, 50/50, and 100. The glass transition temperature of the polymers was measured and the results are shown in FIG. 6. As shown, the respective glass transition temperatures of the lipoate ester and poly (n-butyl acrylate) (PnBA) are similar and, as a result, the lipoate ester co-polymers exhibited a glass transition temperature in a range between the glass transition temperatures of lipoate ester and poly(n-butyl acrylate) (PnBA) homopolymers.

### Example 4: Potential Synthetic Route for PSAs (LpOH-nBA-AA)

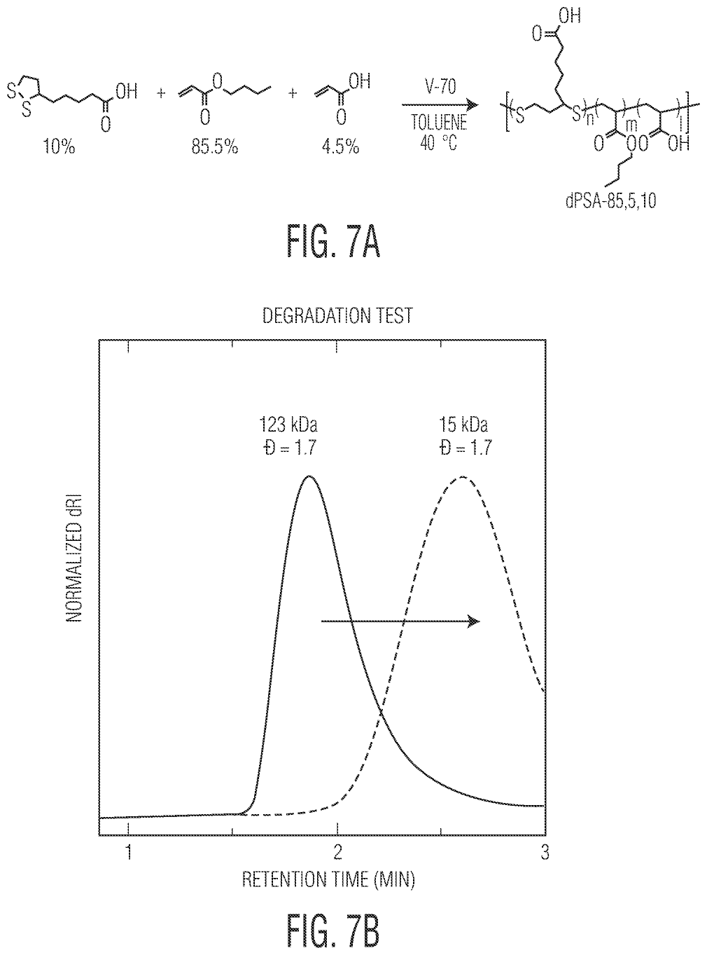

Monomer units of lipoic acid (10 mol %), n-butyl acrylate (85.5 mol %) and acrylic acid (4.5 mol %) were polymerized according to the reaction conditions set forth in FIG. 7A to obtain a degradable polymer. Samples of the degradable polymer were chemically degraded and the molecular weights of the undegraded polymer and degradation products obtained from reactions are shown in FIG. 7B. The undegraded polymer had a number average molecular weight of 123 kDa relative to polystyrene standards. The number average molecular weight of the degradation product was 15 kDa relative to polystyrene standards.

### Example 5: Comparison with Reference Pressure Sensitive Adhesive

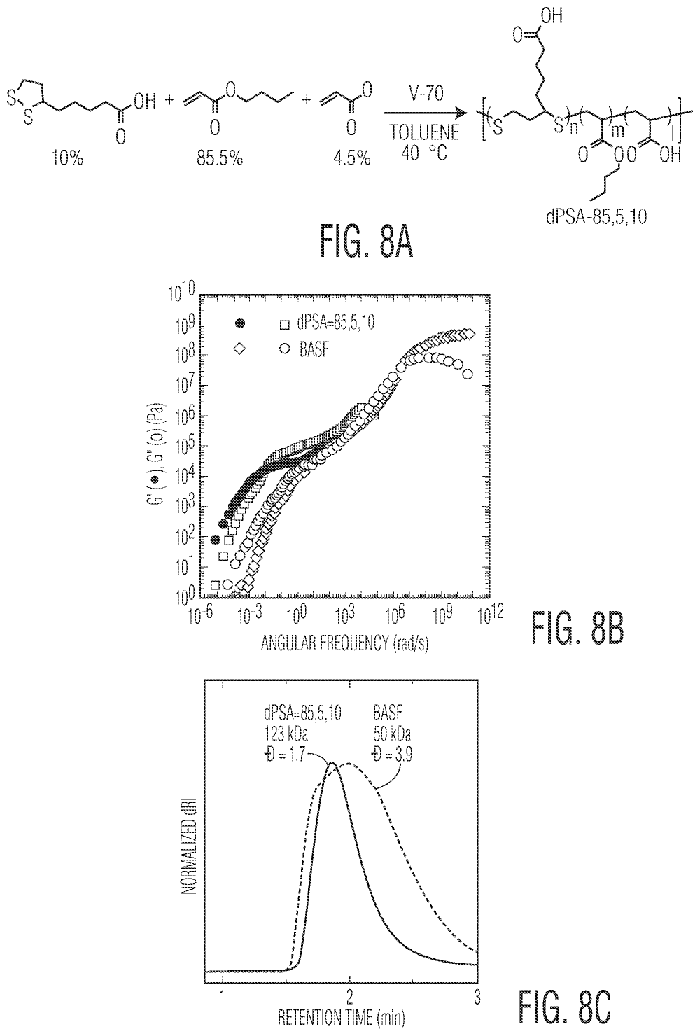

The degradable polymer prepared in Example 4 was compared to conventional pressure sensitive adhesive lacking an organosulfur monomer. The conventional pressure sensitive adhesive contained, on a main monomer basis, 95% n-butyl acrylate and 5% acrylic acid. A 100% resin had a zero-shear viscosity at 130° C. of about 40 Pas. Reaction conditions for the degradable polymer are set forth in FIG. 8A. The storage modulus (•) and loss modulus (º) were compared to a conventional pressure sensitive adhesive (PSA) and results are shown in FIGS. 8B. The as-synthesized molecular weight distribution of the degradable polymer prepared in Example 4 (dPSA) was compared to a conventional pressure sensitive adhesive (PSA) and results are shown in FIG. 8C.

### Example 6: Potential Synthetic Route for PSAs (LpOEt-nBA-AA)

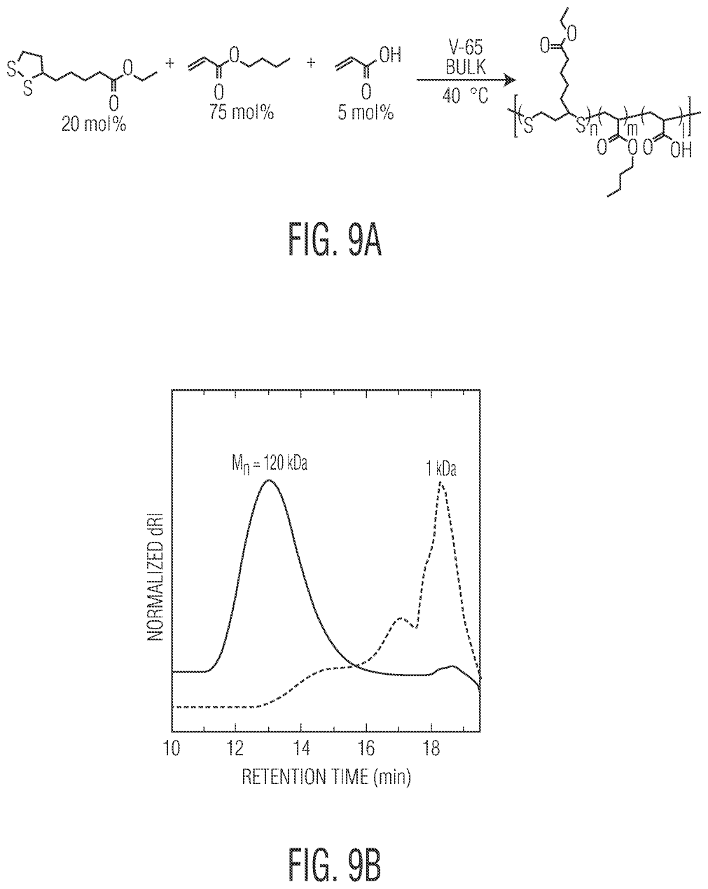

Monomer units of ethyl lipoate (20 mol %), n-butyl acrylate (75 mol %) and acrylic acid (5 mol %) were polymerized according to the reaction conditions set forth in FIG. 9A to obtain a degradable polymer. Samples of the degradable polymer were chemically degraded and the molecular weights of the undegraded polymer and degradation products obtained from reactions are shown in FIG. 9B. The undegraded polymer had a number average molecular weight of 120 kDa relative to polystyrene standards. The number average molecular weight of the degradation product was 1 kDa relative to polystyrene standards.

### Example 7: Potential Synthetic Route for PSAs (LpOEt-nBA-tBA)

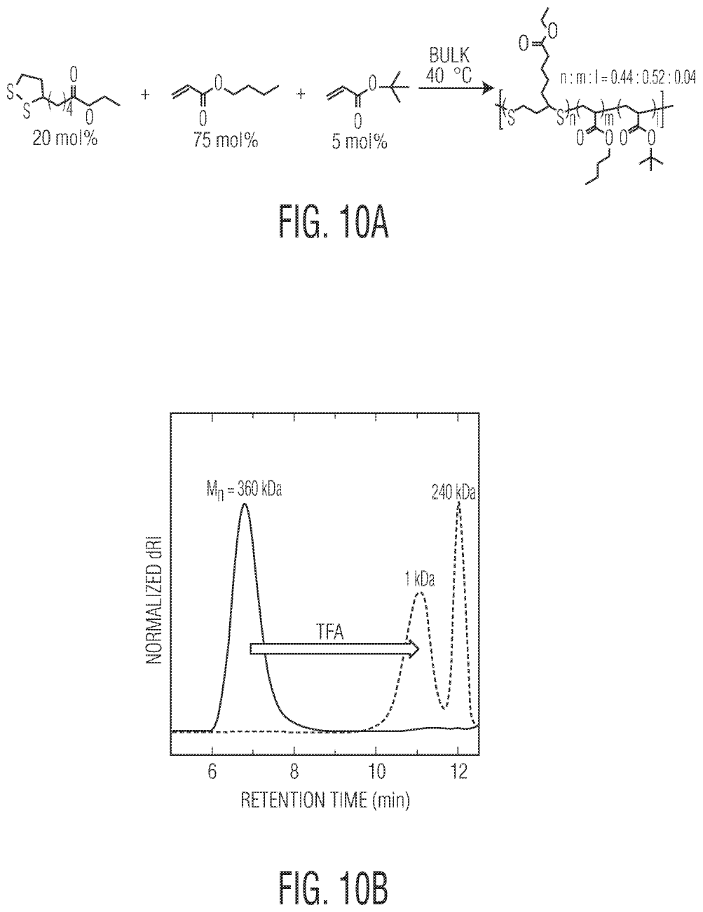

Monomer units of ethyl lipoate (20 mol %), n-butyl acrylate (75 mol %) and tert-butyl acrylate (5 mol %) were polymerized according to the reaction conditions set forth in FIG. 10A to obtain a degradable polymer. Samples of the degradable polymer were chemically degraded with trifluoroacetic acid and the molecular weights of the undegraded polymer and degradation products obtained from reactions are shown in FIG. 10B. The undegraded polymer had a number average molecular weight of 360 kDa relative to polystyrene standards. The number average molecular weights of the degradation products were 1 kDa and 240 Da relative to polystyrene standards.

### Example 8: Potential Synthetic Route for Elastomer (LpOEt-nBA-DiAc)

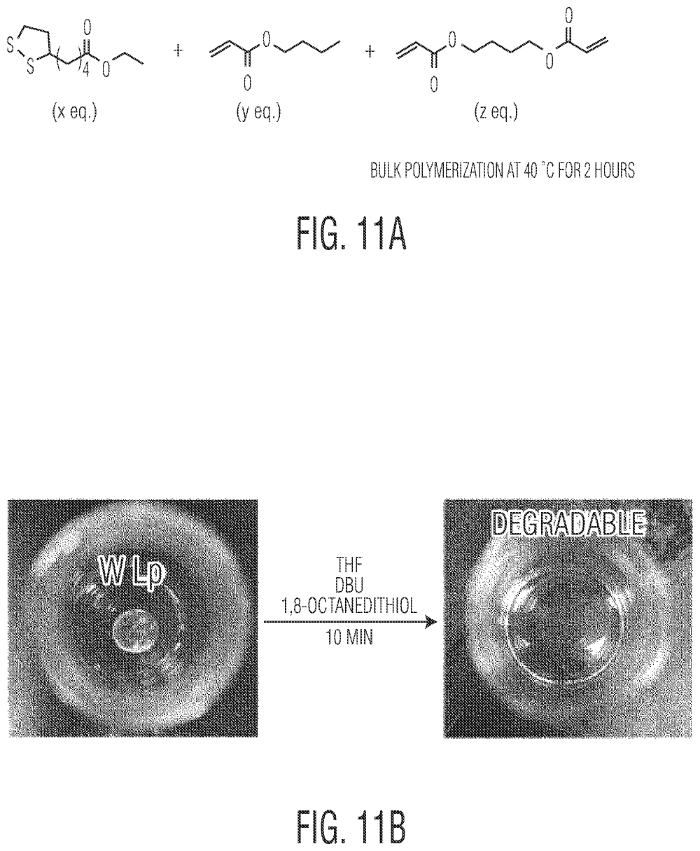

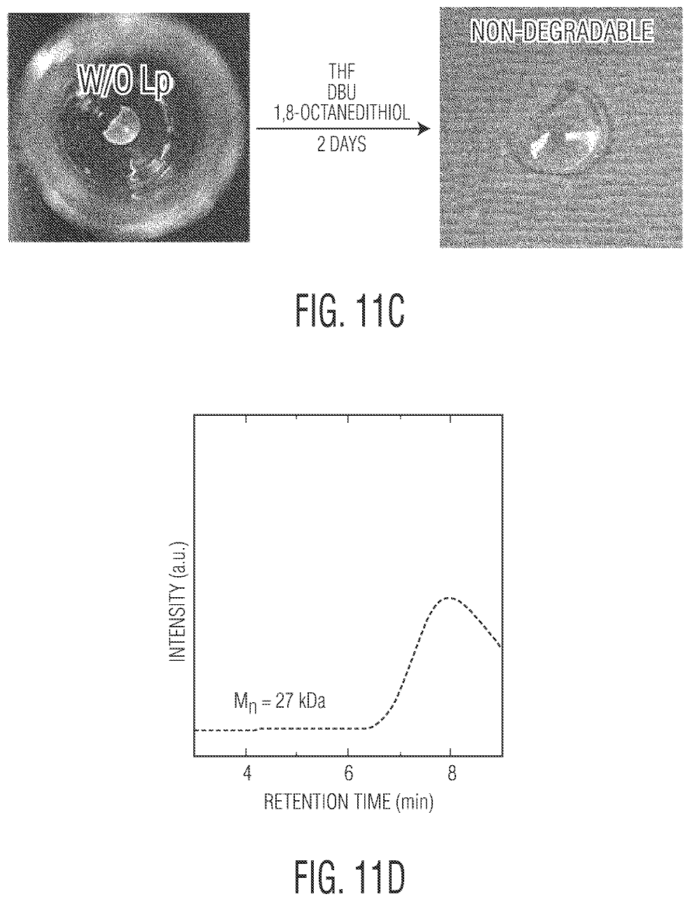

As shown in FIG. 11A, degradable elastomer polymers were prepared from ethyl lipoate, n-butyl acrylate and 1,4-butanediol diacrylate under bulk polymerization at 40° C. for 2 hours. The elastomer polymers were prepared at the molar ratios set forth in Table 1.

TABLE 1

| Sample name | x:y:z | Gel fraction (%) |
|---|---|---|
| W Lp | 20:79:1 | 53% |
| W/O Lp | 0:99:1 | 71% |

The elastomer prepared with ethyl lipoate (W Lp) was observed and treated with diazabicyclo[5.4.0]undec-7-ene (DBU) and 1,8-octanedithiol, acid, using tetrahydrofuran (THF) as a solvent under the conditions shown in FIG. 11B. The elastomer prepared without ethyl lipoate (W/O Lp) was observed and treated with diazabicyclo[5.4.0]undec-7-ene (DBU) and 1,8-octanedithiol, acid, using tetrahydrofuran (THF) as a solvent under the conditions shown in FIG. 11C. A comparison of FIG. 11B and FIG. 11C confirms that the elastomer prepared with ethyl lipoate was readily degradable, whereas the elastomer prepared without ethyl lipoate was not degradable even after two days. The molecular weights of the degradation products obtained from the elastomer prepared with ethyl lipoate were measured and are shown in FIG. 11D.

### Example 9: Post-Functionalization of Degraded Polymer

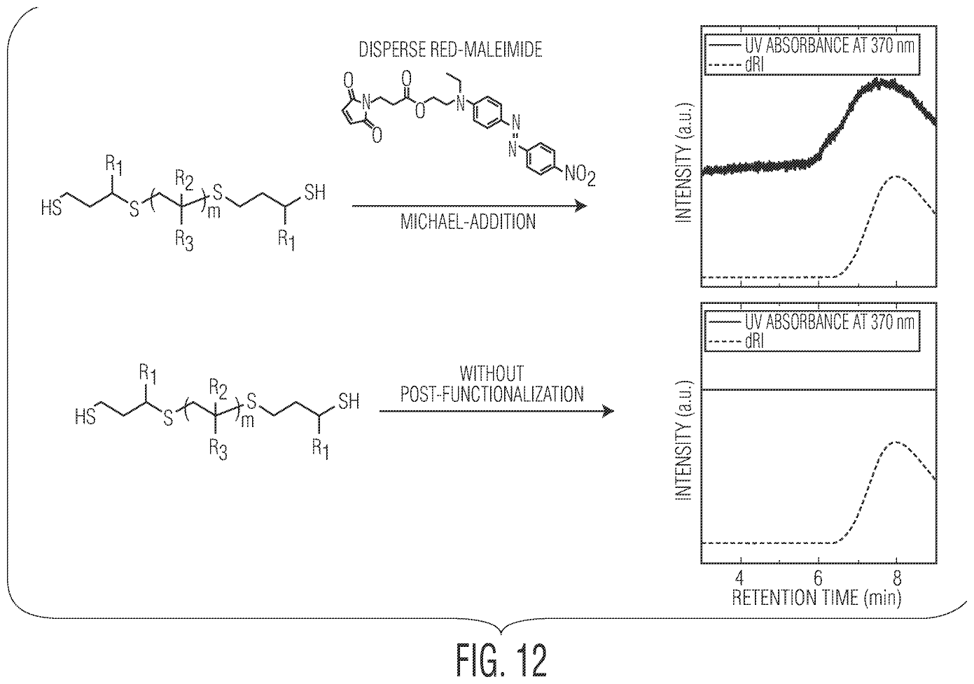

Polymers were prepared with and without functionalization by Michael addition with disperse red-maleimide as shown in FIG. 12 after degradation. The UV absorbance of the degradation products was measured and is shown in FIG. 12. It could be seen that the polymer is conjugated by the dye and that the low molecular weight polymer materials are degradation products of the polymer.

### Example 10: Versatility with Styrene

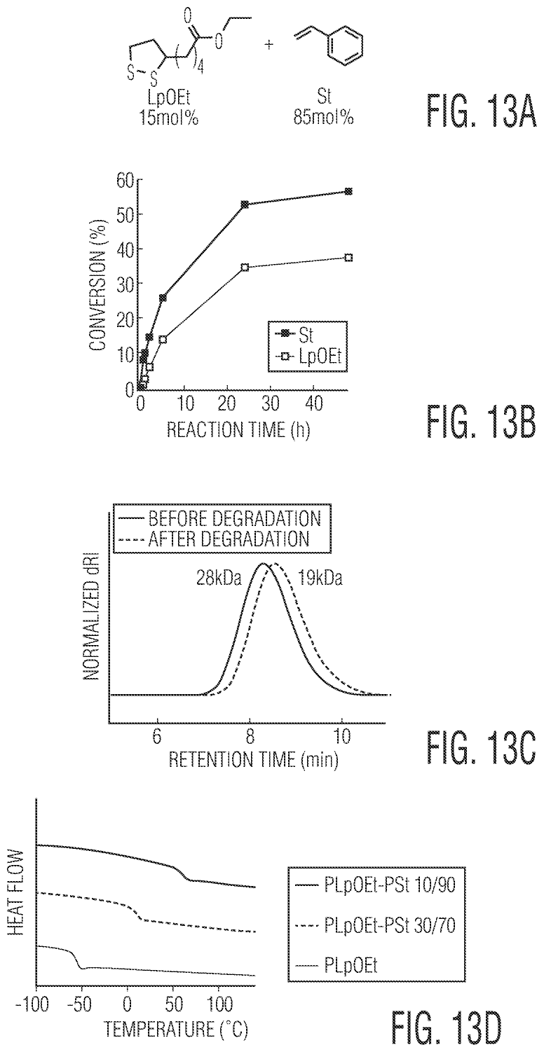

Monomer units of ethyl lipoate (15 mol %) and styrene (85 mol %) were polymerized as set forth in FIG. 13A to obtain a degradable polymer. The conversion of the monomer over a 40-hour period was evaluated and the results are shown in FIG. 13B. The molecular weights of the undegraded polymer and the degradation products were measured and the results are shown in FIG. 13C. Additional polymers with monomer units of ethyl lipoate and styrene with the molar ratios set forth in FIG. 13D were prepared and the glass transition temperatures were measured.

### Comparative Example 1: Methacrylate Co-monomer

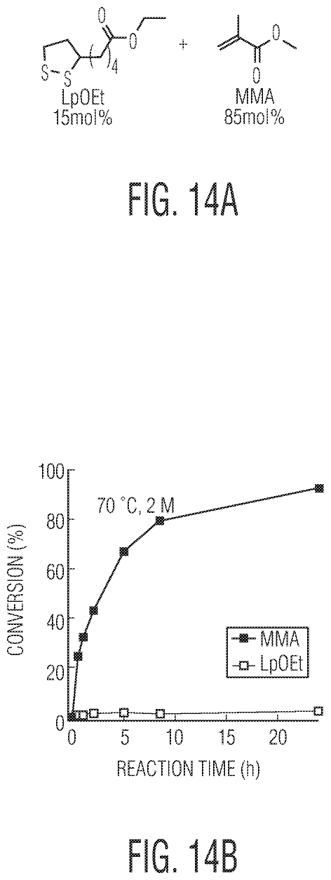

Monomer units of ethyl lipoate (15 mol %) and methacrylate (85 mol %) were subjected to a polymerization reaction as set forth in FIG. 14A. The conversion of the monomer over a 20-hour period was evaluated and the results are shown in FIG. 14B. As shown in FIG. 14B, ethyl lipoate and methacrylate did not form a copolymer.

### Example 11: Preparation of an Emulsion with a Monomer Mass Ratio of 69% n-butylacrylate, 25% lipoic acid, 5% styrene and 1% acrylic acid (w/w)

37.5 g demineralized water, 1.56 g Disponil FES 77, 0.22 g Dowfax 2A1, 1 g ammonia (25% in water) and 0.5 g acrylic acid were added into a 100 mL Erlenmeyer flask. A triangular magnetic stir bar was added, and the mixture was stirred on a magnetic stirring plate at 1000 rpm until a dense foam layer has been formed. A mixture of 2.5 g styrene and 34.5 g n-butylacrylate was added in small portions to form a stable emulsion. The emulsion was stirred for additional 5 minutes. The magnetic stirring plate was set to 500 rpm and 12.5 g of DL-α-lipoic acid was added to the emulsion in small portions while controlling the stability of the emulsion. If any separation was visible the stirring plate was set to 1000 rpm again until the emulsion became stable. After adding the complete amount of lipoic acid, the emulsion was stirred at 1000 rpm for at least 10 minutes.

For introducing the ethyl ester of lipoic acid: the ester was directly miscible with the monomers and the emulsion was prepared by adding the monomers (including the lipoic acid ester) in small fractions into the water phase.

### Examples 12-14: Emulsion Polymerization

0.3 g of polystyrene seed (solid content 33%, diameter 30 nm) was mixed with 50 g water and added into a 250 mL 4-necked round-bottom flask and flushed with nitrogen. The mixture was heated with an oil bath up to 70-75° C. and 5 g of initiator WAKO V50 (1% in water) (2,2′-azobis[2-methylpropionamidin]dihydrochloride) was added. 5 minutes later the emulsion feed with a flow rate of 0.62 g/min for 180 minutes was started. The polymerization was continuously initiated with 20 g WAKO V50 with a flow rate of 0.11 g/min for 180 minutes. Table 2 shows the preparation of the emulsion. Table 3 shows the amount of reactants in the polymerization reaction.

TABLE 2

| | | | | | |
|---|---|---|---|---|---|
| | Corrected | | | pphm | |
| Amount | Amount | Ingredient | Content | actual | mol % |

| | | | | | | | |
|---|---|---|---|---|---|---|---|
| Initial | 1 | 50.00 | g | Demineralized | 100.00% | 100.00 | 769.24 |
| charge 1 | | | | Water | | | |
| | 2 | 0.30 | g | Pre-product 6772 | 33.00% | 0.20 | |
| | 9 | 50.3 | g | | Solid Content: | 0.2% | |
| Emulsion 1 | 1 | 37.50 | g | Demineralized | 100.00% | 75.00 | 576.93 |
| | | | | Water | | | |
| | 2 | 1.56 | g | Disponil FES 77 | 32.00% | 1.00 | |
| | 3 | 0.22 | g | Dowfax 2A1 | 45.00% | 0.2 | |
| | 4 | 1.00 | g | Ammonia | 25.00% | 0.50 | 4.07 |
| | 5 | 0.50 | g | Acrylic acid | 100.00% | 1.00 | 1.92 |
| | 6 | 34.50 | g | n-Butyl acrylate | 100.00% | 69.00 | 74.62 |
| | 7 | 2.50 | g | Styrene | 100.00% | 5.00 | 6.65 |
| | 8 | 12.50 | g | DL-alpha-Lipoic | 100.00% | 25.00 | 16.80 |
| | | | | acid | | | |
| | 9 | 90.28 | g | | Solid Content: | 56.32% | |
| Initiator 1 | 1 | 25.00 | g | Wako V 50 | 1.00% | 0.50 | 0.26 |
| | 9 | 25 | g | | Solid Content: | 1% | |

TABLE 3

| | Example No. | | |
|---|---|---|---|
| | 12 | 13 | 14 |
| Lipoic Acid | 50 | 25 | − |
| Lipoic Acid Ester | − | − | 25 |
| nBA | 44 | 69 | 69 |
| S | 5 | 5 | 5 |
| AA | 1 | 1 | 1 |
| Solid content [%] | 20 | 26 | 26 |
| pH value | 5.7 | 6.2 | 4.0 |
| gel content [% in MEK] | 0 | 0 | 0 |
| Glass transition [° C.] | 30 | 20 | −20 |
| Finger tack test | − | − | ++ |

### Example 15: Entanglement Molecular Weight

To quantify the entanglement molecular weight (Mₑ) of PELp homopolymer, a high molecular weight sample (Table 4) was measured in oscillatory shear. The master curve was generated via isothermal frequency sweeps at fixed strain amplitudes over a frequency of 0.1≤ω≤100 rad/s. Horizontal shift factors were applied to each frequency series. The plateau modulus (G_{N}⁰) taken at the frequency corresponding to a minimum in tan δ was used to calculate Mₑ according to the convention reported by Fetters, L. J., et al. Connection between Polymer Molecular Weight, Density, Chain Dimensions, and Melt Viscoelastic Properties. Macromolecules 1994, 27 (17), 4639-4647, where R, T, and ρ, are the gas constant, absolute temperature, and mass density, respectively. Entanglement molecular weight was calculated using Equation 1.

$${M}_{e} = \frac{4}{5} \frac{ρ RT}{{G}_{N}^{0}} \qquad Equation 1$$

TABLE 4
Characterization of PELp homopolymer

| Mₙ (kg/mol)^{a} | [symbol] | Tg (° C.)^{b} | ρ (g/cm³)^{c} | G_{N}⁰ (Pa)^{d} | Mₑ (kg/mol)^{e} |
|---|---|---|---|---|---|
| 300 | 1.7 | −50 | 1.15 | 7300 | 31 |

^{a}Number-average molar mass and Ð determined using SEC with THF as the eluent.
^{b}Glass transition temperature determined from DSC at a ramp rate of 10° C./min.
^{c}Homopolymer densities were measured using a pycnometer at 25° C..
^{d}Plateau modulus determined from the minimum in tan δ with a reference temperature T_{ref} = 25° C..

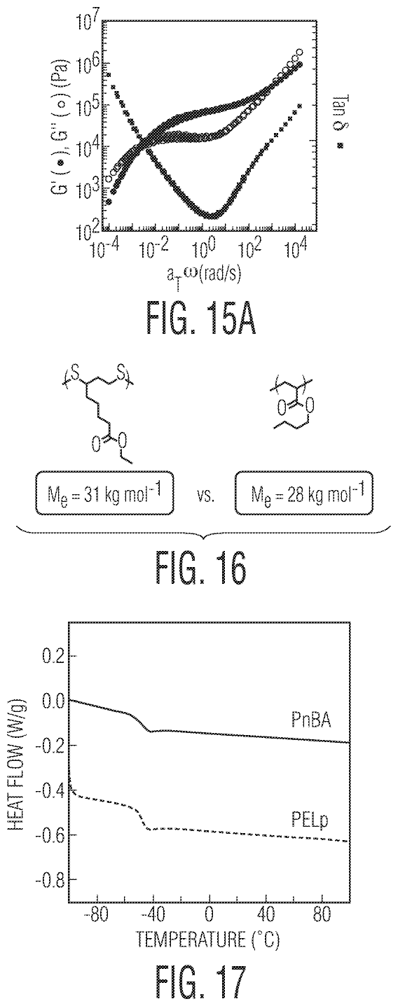

Result show that key viscoelastic and thermal properties of poly(ethyl lipoate) (PELp) are very similar to poly(n-butyl acrylate) (PnBA) (FIG. 15), including entanglement molecular weights determined rheometrically, M_{e,PELp}=31 kg mol⁻¹ vs. M_{e,PnBA}=28 kg mol⁻¹ (FIG. 16), 41 and T_{g,PELp}=T_{g,PnBA}=−50° C. (FIG. 17). Partially replacing n-butyl acrylate with ELp and acrylic acid with αLA should therefore retain the salient performance of conventional poly(acrylate) PSAs but confer substantially better degradability.

### Example 16: Degradation of ELp-nBA with TCEP

In a 4 mL dram vial, ELp-nBA (150 mg, 0.09 mmol) was dissolved in minimal THF. A solution of TCEP (5 equiv. to thiol) in THF/water (4:1) was added and the reaction was run for 16 h at 60° C. DCM was added to the reaction mixture and the degraded polymer was washed with NaHCO₃ (10 mL×1) and purified via precipitation in cold methanol (15 mL×2). SEC: Mnₙ₌3.9 kg mol⁻¹. The degradation reaction is shown below.

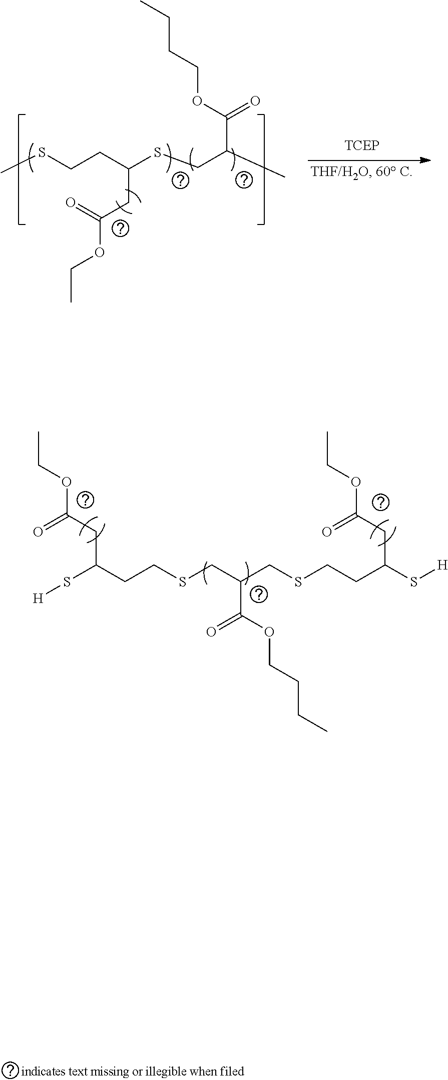

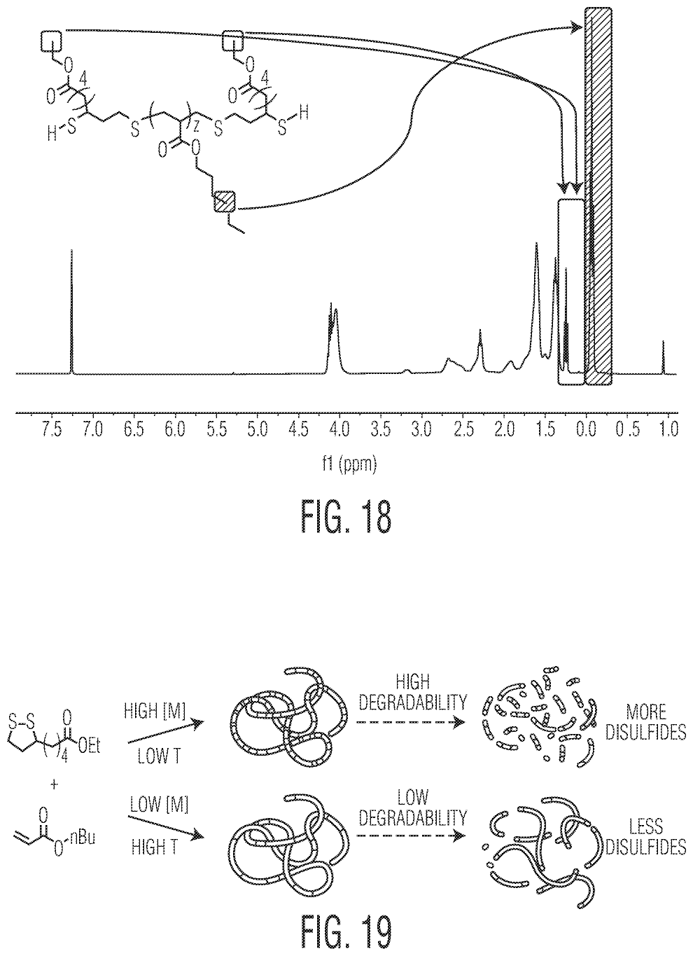

The degraded ELp-nBA was analyzed by ¹H-NMR as shown in FIG. 18. Importantly, the resulting material has a significantly higher number-average molecular weight (Mₙ=140 g mol⁻¹) than previous reports—a range that is actually suitable for PSAs (M»Mₑ). As shown in Table 5, a substantial reduction in molecular weight (e.g., 140→3.9 kg mol⁻¹) upon exposure to tris(2-carboxyethyl) phosphine (Table 5), a chemical reductant that reduces the disulfide bonds in ELp-ELp diads, was demonstrated.

TABLE 5
Summary of copolymers synthesized 40° C. and corresponding degradation results

| ELp | Total | | | | | | | |
|---|---|---|---|---|---|---|---|---|
| feed | monomer | Reaction | ELp | | | | Mₑ (kg mol⁻¹) | |
| ratio | concentration | time | composition | Conversion (%) | | | Before | After |
| (mol %) | (M) | (min) | (mol %) | Total | PELp | PnBA | degradation | degradation |
| 5 | 1 | 15 | 11 | 4.4 | 7.4 | 4.2 | 110 | 45 |
| | 2 | 7 | 11 | 3.7 | 8.7 | 3.4 | 130 | 27 |
| | 4 | 5 | 12 | 6.8 | 12 | 6.6 | 160 | 16 |
| 10 | 1 | 15 | 19 | 3.2 | 3.7 | 3.2 | 110 | 17 |
| | 2 | 7 | 21 | 2.2 | 5.4 | 1.9 | 150 | 7.6 |
| | 4 | 5 | 22 | 4.6 | 9.1 | 4.1 | 210 | 5.1 |
| 15 | 1 | 15 | 26 | 2.6 | 5.0 | 2.2 | 100 | 7.6 |
| | 2 | 7 | 30 | 1.9 | 2.2 | 1.8 | 140 | 3.9 |
| | 4 | 5 | 34 | 2.8 | 2.9 | 2.8 | 200 | 2.6 |

### Example 17: Effect of Polymerization Conditions on Degradation

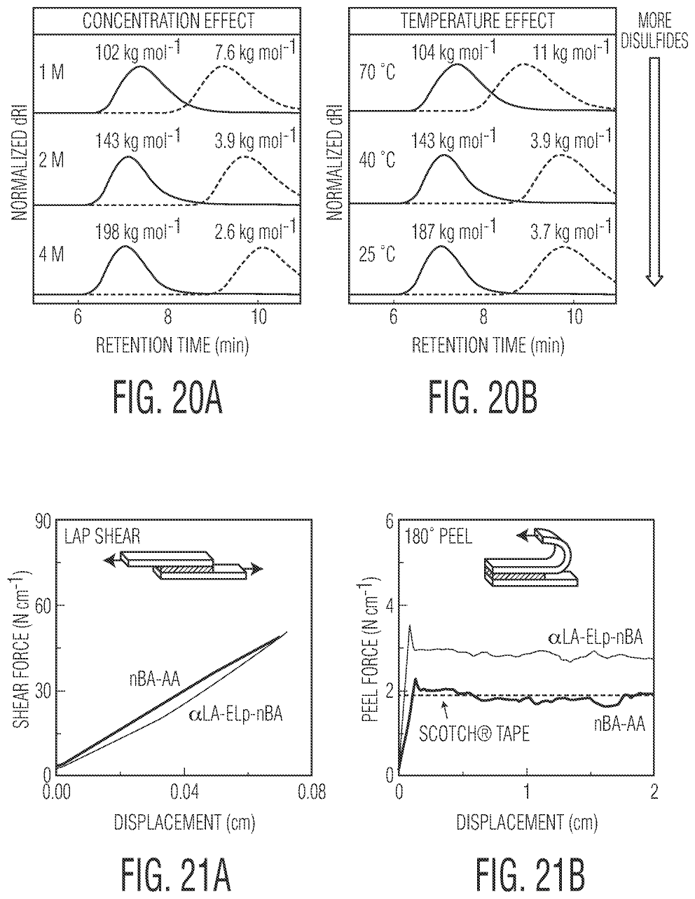

The Applicant has further surprisingly discovered that the reaction conditions during polymerization of nBA-ELp copolymers, as an example, may influence degradability. See, FIG. 19. Larger absolute monomer concentrations (total [M], FIG. 20A) and lower reaction temperatures (T, FIG. 20B) result in higher as-synthesized molecular weights yet smaller oligomers after degradation.

Although unexpected based on common acrylate copolymerization behavior, these results can be understood through an analysis of reaction kinetics. In the ‘terminal model’—wherein the rate of monomer addition depends only on the chemical identity of a propagating chain end—the ‘copolymer equation’ is often used to relate the feed and polymer compositions at any instance in time. Within this framework, the absolute concentration (e.g. expressed in mol cm⁻³) of monomers 1, [M₁], and 2, [M₂], has no influence on polymer composition since [M₂]/[M₁] always appears as a ratio. Any temperature-dependence is also minimal because the various propagation rate constants typically exhibit small differences in activation energy and are subsumed into so-called reactivity ratios r₁ and r₂. However, the copolymer equation is predicated on each propagation step being irreversible. Literature suggests this may not be true for nBA-ELp copolymerization as ELp homopolymerization exhibits a ceiling temperature (T_{c}=139° C.) that is characteristic of an equilibrium arising from reversible monomer addition.

In 1971, Wittmer derived an analogue of the copolymer equation that can handle reversible monomer addition for one (shown below) or both components:

$$\frac{d [ {M}_{1} ]}{d [ {M}_{2} ]} = \frac{1 + {r}_{1} \frac{[ {M}_{1} ]}{[ {M}_{2} ]} - {r}_{1} \frac{{K}_{1}}{[ {M}_{2} ]} ( 1 - {x}_{1} )}{1 + {r}_{2} \frac{[ {M}_{2} ]}{[ {M}_{1} ]}} , \qquad Equation 2$$

where d[M₁]/d [M₂] is the instantaneous composition of polymer being formed, K₁ is the equilibrium constant characterizing the rate of depropagation vs. propagation, and X₁(r₁, K₁ [M₁], [M₂]) is a function of the same variables and abbreviated in Equation 2. In Example 17, we define component 1 as ELp and 2 as nBA. As is evident in Equation 2, the instantaneous composition of polymer includes a term that scales as K₁/[M₂], which depends on both the absolute concentration [M₂] and temperature through the equilibrium constant K₁.

The copolymerization of ELp or αLA with nBA exhibits reversibility in the propagation of 1,2-dithiolane monomer, which explains the pronounced dependence of degradability on both the concentration and temperature used during polymerization. [M₂] and T control the average sequence of monomers along a polymer chain, with higher [M₂] and lower T favoring the formation of ELp-ELp units containing degradable disulfide bonds.

Additionally, application of Equation 2 at low monomer conversions provided an estimate of the reactivity ratios for an nBA-ELp copolymerization: r_{ELp}=18.5 and InBA=0.36. These values accentuate two features of acrylate-1,2-dithiolane polymerizations that are necessary for efficiently forming degradable poly(acrylates): (i) lipoate is readily incorporated into growing polymer chains (rELp»1, mnBA<1), and (ii) lipoate radicals preferentially add to lipoate monomer (rELp»1), both of which generate degradable disulfide bonds.

### Example 18: Adhesive Performance

A poly(lipoic acid-co-ethyl lipoate-co-n-butyl acrylate) (αLA-ELp-nBA) copolymer comprising 3:58:39 mol % αLA: ELp:nBA was prepared. The αLA:ELp:nBA was formulated with Al(acac) at relatively low loadings to improve cohesive strength through light crosslinking. 0.4 wt % Al(acac) was selected for a detailed comparison of physical properties. A control adhesive (poly(n-butyl acrylate-co-acrylic acid) (nBA-AA) with a composition of 97:3 mol %) was also synthesized to mimic traditional commercial adhesives without additional plasticizer or tackifier.

Degradable (αLA-ELp-nBA) and control (nBA-AA) PSAs were compared. Measurements of cohesive (FIG. 21A) and adhesive (FIG. 21B) strength by lap-shear tests with a uniaxial extension rate of 0.5 mm min⁻¹ and 180° peel tests with a uniaxial extension rate of 100 mm min⁻¹ confirm similar performance of degradable and non-degradable control analogs.

### Example 19: Recyclability of Removable Labels

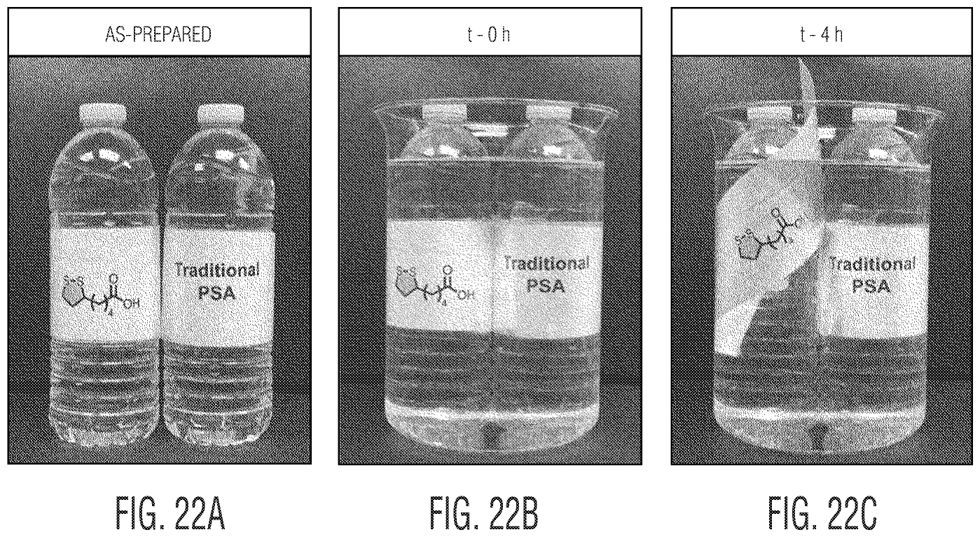

An acrylic PSA and αLA-ELp-nBA were used as adhesives to adhere labels to plastic water bottles. Unlike the acrylic PSAs, αLA-ELp-nBA when used as an adhesive of a bottle label degrades cleanly from between the label and bottle when immersed in 4:1 by volume THF:water containing 1 eq. of tris(2-carboxyethyl) phosphine (TCEP). The label adhered using αLA-ELp-nBA was detached from the bottle after 4 hours of immersion whereas the label adhered by acrylic PSA remained attached to the bottle. FIG. 22A shows the labels as prepared on the bottles, FIG. 22B shows the bottles submerged in THF:water at t-0 hours and FIG. 22C shows the bottles after t=4 hours in THF:water.

### Example 20: Closed-Loop Recycling

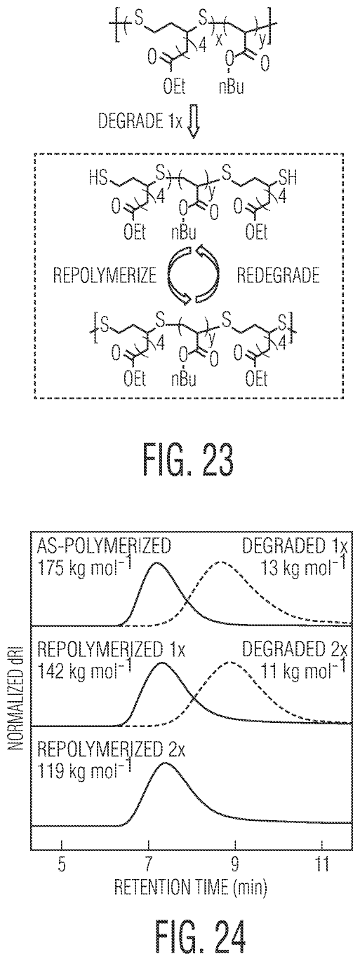

In principle, reduction of the disulfide bonds along as-synthesized polymer chains yields telechelic fragments with thiols at each chain end. Coupling experiments on the degraded fragments with maleimide-Disperse Red 1 in the presence of 1,8-diazabicyclo(5.4.0)undec-7-ene (DBU) suggest there are indeed thiols present at both chain-ends as monitored by SEC with a UV-absorbance detector. These thiols can be exploited to cycle between polymerized and degraded adhesive as shown schematically in FIG. 23.

For example, an as-synthesized ELp-nBA copolymer (Mₙ, original=175 kg mol⁻¹) that was initially degraded into fragments with Mₙ=13 kg mol⁻¹ can be oxidatively repolymerized using I₂ and pyridine to reform disulfide bonds and recover 81% of the original molecular weight (M_{n,1x}=142 kg mol⁻¹). See, FIG. 24. Subjecting this sample to the same TCEP degradation conditions again reduces Mn to 11 kg mol⁻¹ and another repetition reforms polymer with M_{n,2x}=119 kg mol⁻¹. See, FIG. 24. Although there is a modest reduction in molecular weight after repeated cycling, these values remain sufficient for adhesive applications.

Although features and elements are described above in particular combinations, one of ordinary skill in the art will appreciate that each feature or element can be used alone or in any combination with the other features and elements. In addition, the compositions and methods described herein may be implemented in coatings or films in the packaging industry, adhesives, including pressure sensitive adhesives, paper coating, printing inks, foils, personal care/cosmetic, e.g. for hair, skin, wash, laundry, agriculture, e.g. seed protection, resins, films, solutions, and emulsion/dispersion.

1. A degradable polymer which is a copolymer of:
a) up to 50 mol % of an organosulfur monomer comprising a cyclic disulfide group, and
b) at least 50 mol % of at least one organic monomer selected from the group of an acid functional monomer, a base functional monomer, a polar monomer, a vinyl monomer or a combination thereof;
wherein a primary backbone of the degradable polymer comprises disulfide bonds.

2. (canceled)

3. The degradable polymer of claim 1, wherein the organic monomer is selected from the group of styrene, an acrylate, and a vinyl acetate.

4. (canceled)

5. The degradable polymer of claim 1, wherein the cyclic disulfide group comprises 1 to 8 carbon atoms.

6. The degradable polymer of claim 1, wherein the organosulfur monomer comprises lipoic acid or a derivaive thereof.

7. The degradable polymer of claim 1, wherein the organosulfur monomer has the structure of Formula (I): 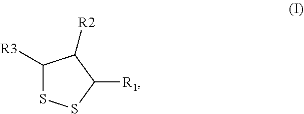
where R₁, R₂ and R₃ are each independently selected from the group of hydrocarbyl, substituted hydrocarbyl, hetero-hydrocarbyl, and substituted hetero-hydrocarbyl, optionally with a functional group selected from the group of amino, ammonio, imino, amido, imidyl, nitrile, azo, azido, cyano, cyanato, isocyanato, isothiocyanto, hydrazide, nitro, nitroso, nitrosooxy, pyridyl, hydroxyl, alkoxy, carboxyl, ester, acyl, halo, haloformyl, phosphino, phosphoric, phospho, sulfide, disulfide, thio, thiol, sulfonyl, sulfo, sulfinyl, alkenyl, alkynl, allenyl, and silyl.

8. The degradable polymer of claim 1, wherein the degradable polymer comprises a mole ratio at least 1 mol % of a styrene monomer in combination with an organic monomer other than styrene.

9. (canceled)

10. The degradable polymer of claim 1, wherein a number average molecular weight of the degradable polymer is greater than 100,000 Da.

11. The degradable polymer of claim 1, wherein the degradable polymer is cross-linked.

12. The degradable polymer of claim 1, wherein a ratio of the molecular weight of degradation products of the degradable polymers relative to the degradable polymer is from 0.001 to 0.1.

13. A method of producing a degradable polymer comprising polymerizing up to 50 mol % of an organosulfur monomer comprising a cyclic disulfide group with at least 50 mol % of at least one organic monomer selected from the group of an acid functional monomer, a base functional monomer, a polar monomer, a non-polar monomer, a vinyl monomer or a combination thereof to obtain a degradable polymer having a primary backbone comprising disulfide bonds.

14. The method of claim 13, wherein the polymerizing takes place in the presence of an azo or non-oxidizing initiator.

15. The method of claim 13, wherein the polymerizing is solution polymerization or emulsion polymerization.

16. The method of claim 13, wherein the organosulfur monomer is polymerized in an amount of 25 mol % or less.

17. The method of claim 13, wherein the organic monomer is selected from the group of a styrene, an acrylate, and a vinyl acetate.

18. (canceled)

19. The method of claim 13, wherein the cyclic disulfide group comprises 1 to 8 carbon atoms.

20. The method of claim 13, wherein the organosulfur monomer comprises lipoic acid or a derivaive thereof.

21. The method of claim 13, wherein the organosulfur monomer has the structure of Formula (I): 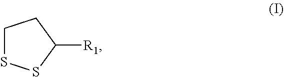
where R1 is selected from the group of hydrocarbyl, substituted hydrocarbyl, hetero-hydrocarbyl, and substituted hetero-hydrocarbyl, optionally with a functional group selected from the group of amino, ammonio, imino, amido, imidyl, nitrile, azo, azido, cyano, cyanato, isocyanato, isothiocyanto, hydrazide, nitro, nitroso, nitrosooxy, pyridyl, hydroxyl, alkoxy, carboxyl, ester, acyl, halo, haloformyl, phosphino, phosphoric, phospho, sulfide, disulfide, thio, thiol, sulfonyl, sulfo, sulfinyl, alkenyl, alkynl, allenyl, and silyl.

22. The method of claim 13, wherein the at least one organic monomer comprises a mass ratio of at least 1 mol % of a styrene monomer in combination with an organic monomer other than styrene.

23. (canceled)

24, (canceled)

25. A pressure sensitive adhesive comprising the degradable polymer of claim 1.

26. A method for recycling the degradable polymer of claim 1 comprising:
a) reducing the disulfide bonds of the degradable polymer to obtain degraded fragments of the degradable polymer, and
b) repolymerizing the degraded fragments of the degradable polymer to obtain a recycled degradable polymer.

27. The method of claim 26, further comprising:
c) reducing disulfide bonds of the recycled degradable polymer to obtain degraded fragments of the recycled degradable polymer, and
d) repolymerizing the degraded fragments of the recycled degradable polymer to obtain a twice-recycled degradable polymer.
